(19) United States
(12) Patent Application Publication
(10) Pub. No.: US 2014/0053945 A1
(43) Pub. Date: Feb. 27, 2014

(54) STORAGE AND DISPENSING BAG AND METHOD OF DISPENSING CONTENTS FROM THE SAME

(71) Applicant: KENNETH B. ALBRITTON, ASHLAND, VA (US)

(72) Inventor: KENNETH B. ALBRITTON, ASHLAND, VA (US)

(21) Appl. No.: 13/973,169

(22) Filed: Aug. 22, 2013

Related U.S. Application Data
(60) Provisional application No. 61/743,182, filed on Aug. 27, 2012.

(51) Int. Cl. B67C 11/02

(52) U.S. Cl. CPC B67C 11/02
USPC 141/1; 141/114

(57) ABSTRACT

A storage and dispensing bag comprises a main body and a spout. The main body forms a cavity for storing contents to be dispensed into a bottle. The spout is connected to the main body and adapted for dispensing the contents from the main body into the bottle. The spout comprises first and second rigid, flexible members affixed to or embedded in opposing sides of the spout adjacent a distal opening. The first rigid, flexible member comprises a first end and a second end. The second rigid, flexible member comprises a first end and a second end. The first and second rigid, flexible members are adapted to each bend outward from the other when longitudinal force is applied at the first ends and at the second ends to cause the opposing sides of the spout to separate to facilitate dispensing of the contents.

### CROSS-REFERENCE TO RELATED APPLICATIONS

This application claims priority to U.S. Provisional Application Ser. No. 61/743,182, filed Aug. 27, 2013, the contents of which are incorporated herein by reference in its entirety.

### FIELD OF THE INVENTION

This invention relates to the field of storage containers and bags. More specifically, the invention comprises a built-in funnel device which replaces the need for a separate funnel and measuring device when utilizing the storage bag's contents.

### BACKGROUND

There are many known bags for storing food and other items. Many are plastic bags with various sizes, colors and shapes. There are different plastic thicknesses for bags depending on the intended use and various means of closure to secure the contents in the bags with some having no closure component other than a means to fold the bags. Many new designs of storage bags have focused on different means to securely close the storage bag.

When a person elects to transport a substance for future consumption or use which may be added into a water bottle or other container, a plastic storage bag is often utilized due to its availability, small size and inexpensive cost. Difficulty is often realized when trying to empty all or a portion of the bag into another container. The opening in the bag frequently does not permit easy distribution of contents, especially if the content of the bag is in powder form. The opening in the typical bag which is adequate to load the bag could misdirect and cause an undesired amount of the contents to be dispensed and could result in spillage when attempting to use this same opening for distribution into a bottle or another container. Even with the use of a separate funnel, spills can be prevalent. One option to transfer contents from a baggie may be the use of a spoon or other device to transport the product inside the bag to another container. After loading the spoon or other device it is often difficult to freely raise the device out of the bag and then direct the contents into a bottle or other container without spillage.

### BRIEF SUMMARY OF THE INVENTION

In one embodiment of the invention, a storage and dispensing bag comprises a main body and a spout. The main body forms a cavity for storing contents to be dispensed into a bottle. The main body has a selectively sealable main opening for placing the contents into the cavity. The spout is connected to the main body and is adapted for dispensing the contents from the main body into the bottle. The spout comprises a proximal opening, a distal opening, and first and second rigid, flexible members. The proximal opening is at a proximal end of the spout. The proximal opening is connected to a corresponding secondary opening in the main body which is separate from the main opening. The distal opening is at a distal end of the spout. The first and second rigid, flexible members are affixed to or embedded in opposing sides of the spout adjacent the distal opening. The first rigid, flexible member comprises a first end and a second end. The second rigid, flexible member comprises a first end and a second end. The first ends of the first and second rigid, flexible members are adjacent each other. The second ends of the first and second rigid, flexible members are adjacent each other. The first and second rigid, flexible members are adapted to each bend outward from the other when longitudinal force is applied at the first ends and at the second ends to cause the opposing sides of the spout to separate to facilitate dispensing of the contents.

The distal opening and the first and second rigid, flexible members may be sized such that, when longitudinal force is applied at the first ends and at the second ends, the distal opening fits within a mouth of a standard disposable water bottle, and such that the longitudinal force may be removed and the mouth of the standard disposable water bottle will prevent the first and second rigid, flexible members from fully returning to original, non-bent positions such that the opposing sides of the spout remain at least partly separated while the distal end remains within the mouth of the standard disposable water bottle. A width of the distal opening when the opposing sides of the spout are not separated may be 35 millimeters or less.

The distal opening and the first and second rigid, flexible members may be sized such that, when longitudinal force is applied at the first ends and at the second ends, the distal opening fits within a mouth of a standard baby bottle, and such that the longitudinal force may be removed and the mouth of the standard baby bottle will prevent the first and second rigid, flexible members from fully returning to original, non-bent positions such that the opposing sides of the spout remain at least partly separated while the distal end remains within the mouth of the standard baby bottle. A width of the distal opening when the opposing sides of the spout are not separated may be 50 millimeters or less.

The spout may be adapted to be folded onto itself at least one time. The folded spout may be adapted to be folded onto the main body. The bag may further comprise a securing device for securing the folded spout to the main body.

In yet another embodiment of the invention, a single-serving storage and dispensing bag comprises an elongated tubular main body and first and second rigid, flexible members. The elongated tubular main body has opposing sealed ends forming a cavity for storing contents to be dispensed into a bottle. One opposing sealed end is adapted to be torn off the main body by a user such that an opening is formed in the main body when the one opposing sealed end is torn off. The first and second rigid, flexible members are affixed to or embedded in opposing sides of the main body adjacent where the opening will be formed in the main body when the one opposing sealed end is torn off. The first rigid, flexible member comprises a first end and a second end. The second rigid, flexible member comprises a first end and a second end. The first ends of the first and second rigid, flexible members are adjacent each other. The second ends of the first and second rigid, flexible members are adjacent each other. The first and second rigid, flexible members are adapted to each bend outward from the other when longitudinal force is applied at the first ends and at the second ends to cause the opposing sides of the main body adjacent the opening formed in the main body to separate to facilitate dispensing of the contents.

The opening formed in the main body and the first and second rigid, flexible members may be sized such that, when longitudinal force is applied at the first ends and at the second ends, the opening formed in the main body fits within a mouth of a standard disposable water bottle, and such that the longitudinal force may be removed and the mouth of the standard disposable water bottle will prevent the first and second rigid, flexible members from fully returning to original, non-bent positions such that the opposing sides of the main body remain at least partly separated while the opening formed in the main body remains within the mouth of the standard disposable water bottle. A width of the main body when the opposing sides of the main body are not separated may be 35 millimeters or less.

The opening formed in the main body and the first and second rigid, flexible members may be sized such that, when longitudinal force is applied at the first ends and at the second ends, the opening formed in the main body fits within a mouth of a standard baby bottle, and such that the longitudinal force may be removed and the mouth of the standard baby bottle will prevent the first and second rigid, flexible members from fully returning to original, non-bent positions such that the opposing sides of the main body remain at least partly separated while the opening formed in the main body remains within the mouth of the standard baby bottle. A width of the main body when the opposing sides of the main body are not separated may be 50 millimeters or less.

In addition to the storage and dispensing bags as described above, other aspects of the present invention are directed to corresponding methods for dispensing contents from a bag into a bottle.

### BRIEF DESCRIPTION OF THE SEVERAL VIEWS OF THE DRAWING(S)

The foregoing summary, as well as the following detailed description of the disclosure, will be better understood when read in conjunction with the appended drawings. For the purpose of illustrating the disclosure, there are shown in the drawings embodiments which are presently preferred. It should be understood, however, that the disclosure is not limited to the precise arrangements and instrumentalities shown. In the drawings:

FIG. 1 is a perspective view of a storage and dispensing bag with a built in funnel folded and secured in place on the bag, in accordance with embodiments of the invention.

FIG. 2 is a perspective view of the bag of FIG. 1, showing the main body of the built in funnel positioned in its down position unsecured from its securing device and the exit canal portion of the funnel still secured by its securing device.

FIG. 3 is a perspective view of the bag of FIG. 1, showing the exit canal portion of the built in funnel in its unsecured position from its securing device as well as the main body of the built in funnel unsecured from its securing device.

FIG. 4 is a perspective view of the funnel of the bag of FIG. 1, showing the exit canal with a wall support designed to hold the exit canal open while the bag contents exits the bag.

FIG. 5 is a perspective view of the funnel of the bag of FIG. 1, showing how a user's fingers could grip the exit canal and, by applying pressure, allow the placement of the funnel's exit canal into a mouth of a bottle.

FIGS. 6A-6C are front views of a storage and dispensing bag, in accordance with alternative embodiments of the invention.

FIG. 7 is a close up view of the funnel of the bag of FIGS. 6A-6C as it is about to be placed into a mouth of a bottle.

FIG. 8 is a cross-sectional view across the mouth of the bottle of FIG. 7 after the funnel of the bag of FIGS. 6A-6C has been placed into the mouth.

FIGS. 9A-B are top views of rigid, flexible members of a storage and dispensing bag, in accordance with two different embodiments of the invention.

FIG. 10 is a front view of a storage and dispensing bag, in accordance with alternative embodiments of the invention.

FIG. 11 is a front view of a single-serving storage and dispensing bag, in accordance with alternative embodiments of the invention.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “top,” “bottom,” “left,” “rear,” “right,” “front,” “vertical,” “horizontal,” and derivatives thereof shall relate to the invention as oriented in the figures. Furthermore, there is no intention to be bound by any expressed or implied theory presented in the preceding technical field, background, or brief summary, or in the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The present invention relates to a storage bag able to dispense its contents through a funnel designed into the bag. The invention can allow the easy measurement of a certain amount of its contents to be dispensed and after the dispensing of the desired amount of contents the funnel opening may be sealed to prevent undesired dispensing, leaking or spilling of the contents. With the funnel shape built into the bag, spillage is less likely and dispensing the contents of the bag invention can be faster and better directed. A funnel with measured amounts marked on the funnel that is built into the bag provides a faster and more convenient means to dispense measured amounts from a bag or baggie container into desired containers.

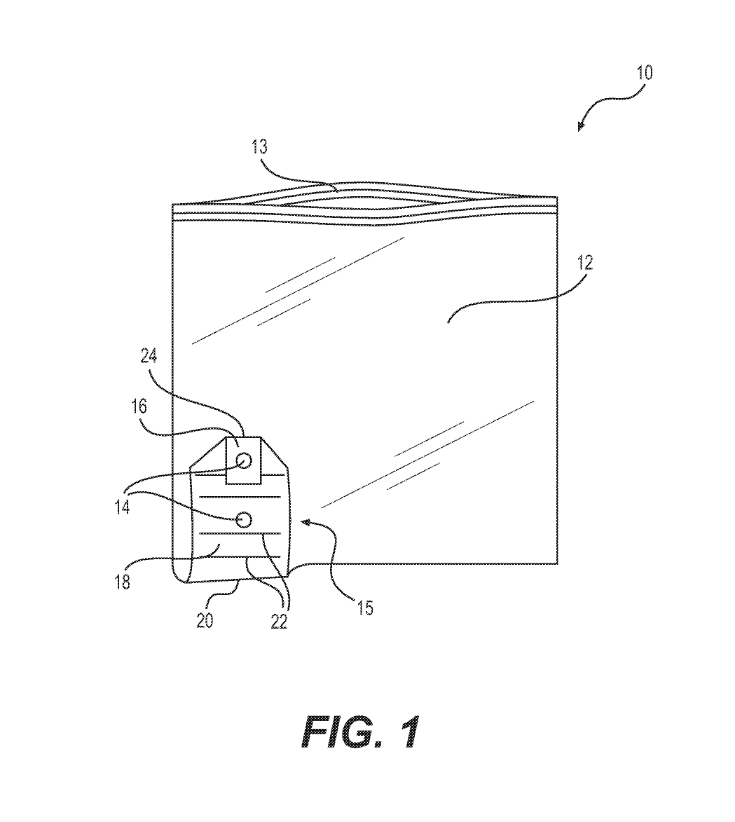

Referring to the drawings in detail, wherein like numerals indicate like elements throughout, FIG. 1 shows a perspective view of a storage and dispensing bag 10 of embodiments of the present invention with the built in funnel 15 in a closed and secured position for storage or transportation. The bag 10 comprises a main body 12 forming a cavity for storing contents to be dispensed into a bottle. The main body 12 has a selectively sealable main opening 13 for placing the contents into the cavity. The selectively sealable main opening 13 may comprise a conventional zipper-type closure, or may comprise a slider-type closure. The bag further comprises a spout or funnel 15 connected to the main body 12. The funnel 15 is adapted for dispensing the contents from the main body into the bottle. The funnel has a proximal opening at a proximal end of the spout. The proximal opening is connected to a corresponding secondary opening in the main body that is separate from the main opening. The proximal opening and the secondary opening meet at the funnel entry closure point 20.

The funnel 15 further comprises a distal opening 17 at a distal end of the funnel. The bag 10 further comprises first and second exit canal wall supports 26a, 26b affixed to or embedded in opposing sides of the funnel adjacent the distal opening. The exit canal wall supports 26a, 26b comprise rigid, flexible members that enable the distal opening 17 to be widened and held in such a widened position while the contents of the bag 10 are dispensed, as described in more detail below.

The main body 18 of the funnel 15 may be folded and then attached to the side of the main body 12 of the storage bag 10 as shown in FIG. 1, such as by utilizing the securing device 14, causing a crease at the funnel entry closure point 20, preventing the contents in the main body 12 of the storage bag 10, from escaping into the main body 18 of the funnel 15. The securing device 14 may comprise any suitable mechanism for selectively securing the main body 18 of the funnel 15 to the main body 12 of the bag 10. For example, the securing device 14 may comprise mating hook and loop fastener components affixed to the funnel and the bag. As another example, the securing device may comprise a mildly adhesive disk or the like affixed to the funnel only, to the bag only, or to the funnel and the bag. When not in use the exit canal 16 of the funnel 15 may be folded and attached to the side of the main body 18 of the funnel 15 by a securing device 14 (which may be the same type of securing device described above, or may be a different type of securing device) creating a crease at the exit canal providing a closure point 24. This is an acceptable position for the built in funnel when not in use providing easier storage and transporting of the storage bag as well as preventing the contents of the main body of the funnel 18 from dispensing unintentionally.

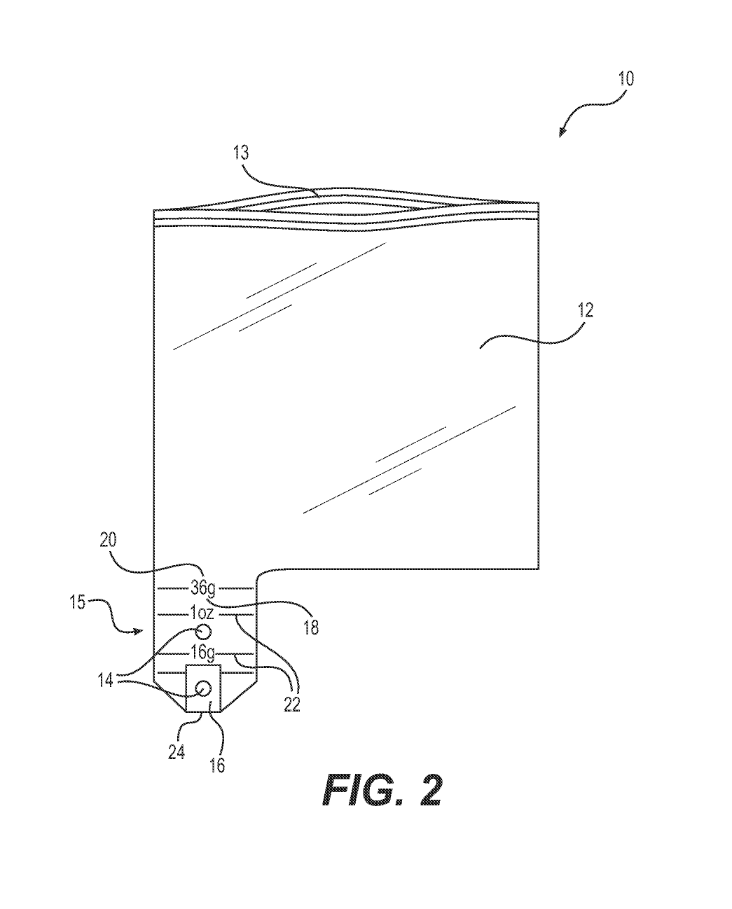

FIG. 2 shows a perspective view of the present invention with the main body 18 of the funnel 15 unfolded with its securing device 14 detached. In this position, the funnel can be filled to desired amounts of the contents using the markings 22 as a guide. The main body 18 of the funnel 15 is detached from the securing device 14, eliminating the fold at the funnel entry closure point 20 and allowing the contents in the main body 12 of the storage bag 10 to flow freely into the main body 18 of the funnel 15. Additional shaking or tilting of the bag may assist the movement of the contents from or back into the main body 12 of the storage bag 10 until the desired amount of the contents is loaded from the main body 12 of the storage bag 10 into the main body 18 of the funnel 15. Once the main body 18 of the funnel 15 is filled to the desired point, the main body 12 of the storage bag 10 may be tilted back in a manner so as to prevent additional contents from entering the main body 18 of the funnel 15. If the main body 18 of the funnel 15 received more contents from the main body 12 of the storage bag 10 than desired, the main body 18 of the funnel 15 may be tilted in a manner to remove the undesired amount from the funnel and placing the undesired amount back into the main body 12 of the storage bag 10. The exit canal 16 of the funnel 15 continues to be folded at the exit canal closure point 24 and attached to the main body 18 of the funnel 15 by a securing device 14, thereby preventing the contents of the main body 18 of the funnel 15 from exiting the funnel until its departure is desired.

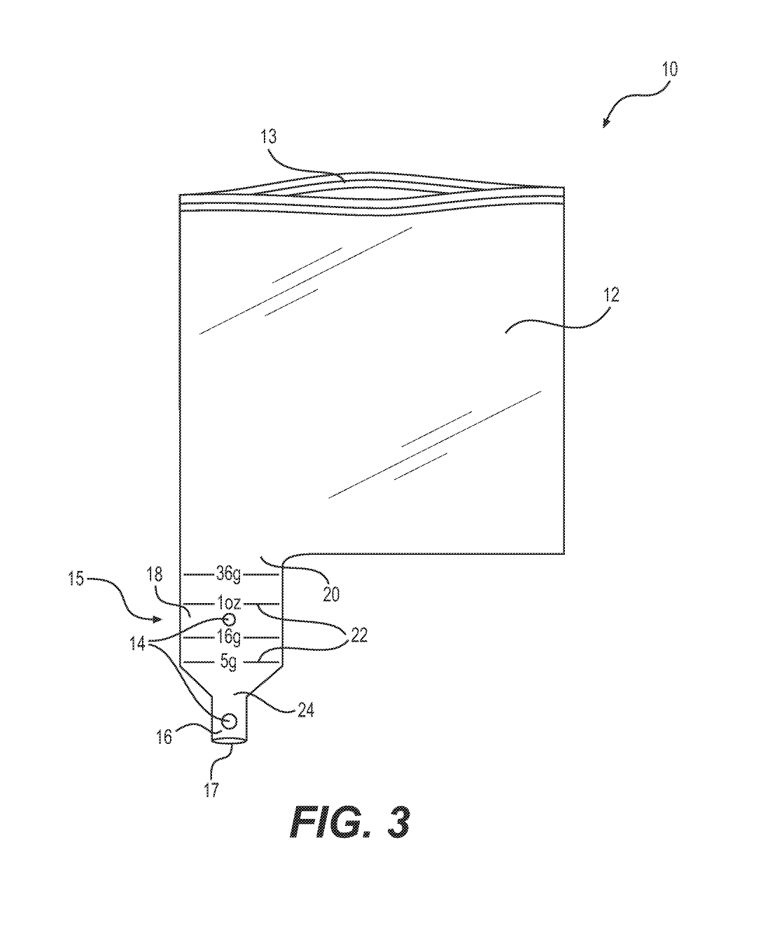

FIG. 3 shows a perspective view of the present invention with both the main body 18 of the funnel 15 in an unfolded open position and the exit canal 16 of the funnel 15, in an unfolded open position. In this position, the contents previously directed into the funnel can be released into a desired container. The exit canal 16 of the funnel 15 is detached from the main body 18 of the funnel 15 by unsecuring the securing device 14, thereby allowing the contents of the main body 18 of the funnel 15 to flow through the exit canal 16 of the funnel 15 and out of the bag 10. The contents may be, for example, directed into a desired bottle or other container. Once the previously measured amount empties into the desired container through the exit canal 16 of the funnel 15, the exit canal 16 can be reattached to the main body 18 of the funnel 15 with the use of a securing device 14. The main body 16 of the funnel 15 can then be reattached to the main body 12 of the storage bag 10 using a securing device 14.

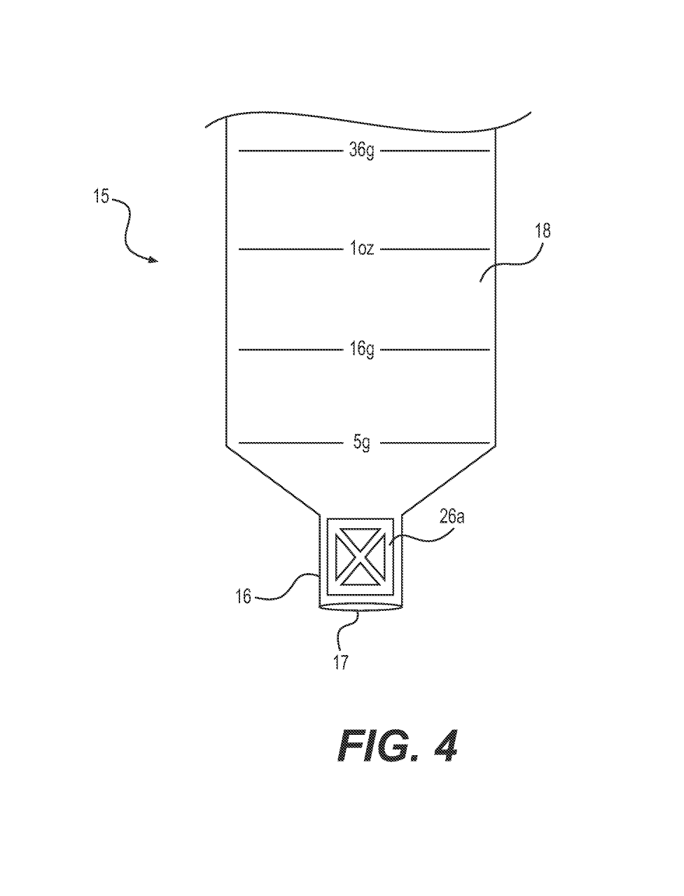

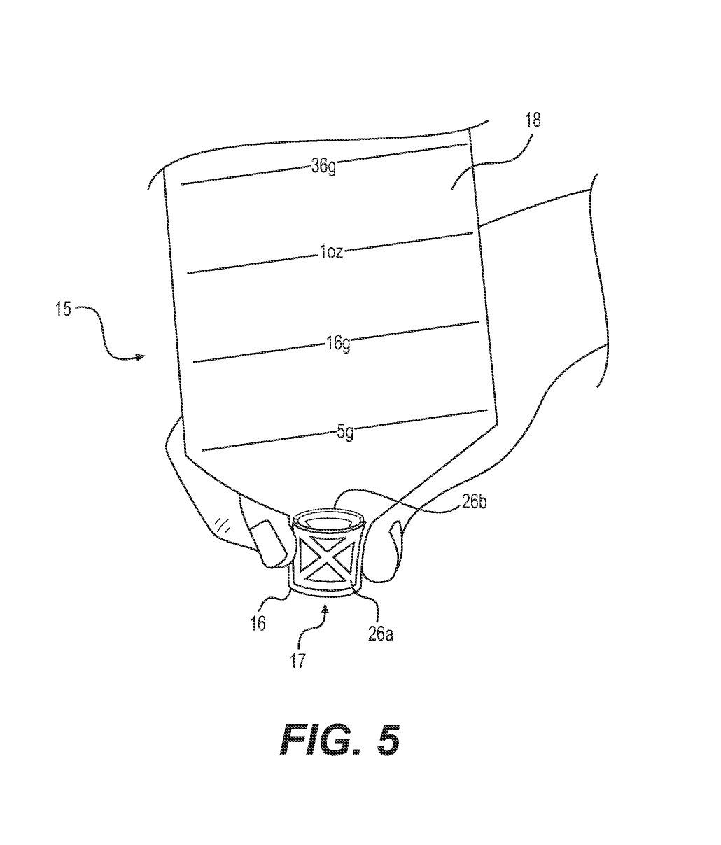

FIG. 4 shows a close up view of the main body 18 of the funnel 15 along with one of the exit canal wall supports 26a designed and included to hold the shape of the container's interior entrance when the contents are being dispensed. FIG. 5. shows a perspective view of the main body 18 of the funnel 15 and depicts how the fingers of a user's hand can grip the side edges of the exit canal 16 of the funnel 15 and, by applying pressure at opposing side edges, cause the exit canal wall supports 26a, 26b to curvedly bend outward from each other. This curvedly bending of the exit canal wall supports 26a, 26b widens the exit canal 16 and correspondingly enlarges the opening 17 to facilitate the flow of contents out of the funnel, while at the same time creates a shape enabling the exit canal 16 of the funnel 15 to be inserted into the mouth of a bottle, such as a standard disposable water bottle or a standard baby bottle. Additionally, the exit canal 16 and the exit canal wall supports 26a, 26b are sized such that, once the exit canal 16 is within the mouth of the bottle, the user may stop applying pressure at the opposing side edges without the exit canal wall supports 26a, 26b returning to their original shapes and causing the opening 17 to close back up. Instead, the exit canal wall supports 26a, 26b will attempt to return to their original shapes (i.e., to straighten out), but will contact the neck of the bottle and therefore be prevented from returning to their original shape (while the exit canal 16 is in the mouth of the bottle). By preventing the exit canal wall supports 26a, 26b from returning to their original shape, the exit canal 16 remains widened and the opening 17 remains enlarged to continue to facilitate the flow of the contents from the funnel 15 into the bottle. The applied pressure that the exit canal wall supports 26a, 26b create against the neck wall of the bottle provides and secures an adequate opening for contents previously loaded in the main body 16 of the funnel 15 to exit into the desired container.

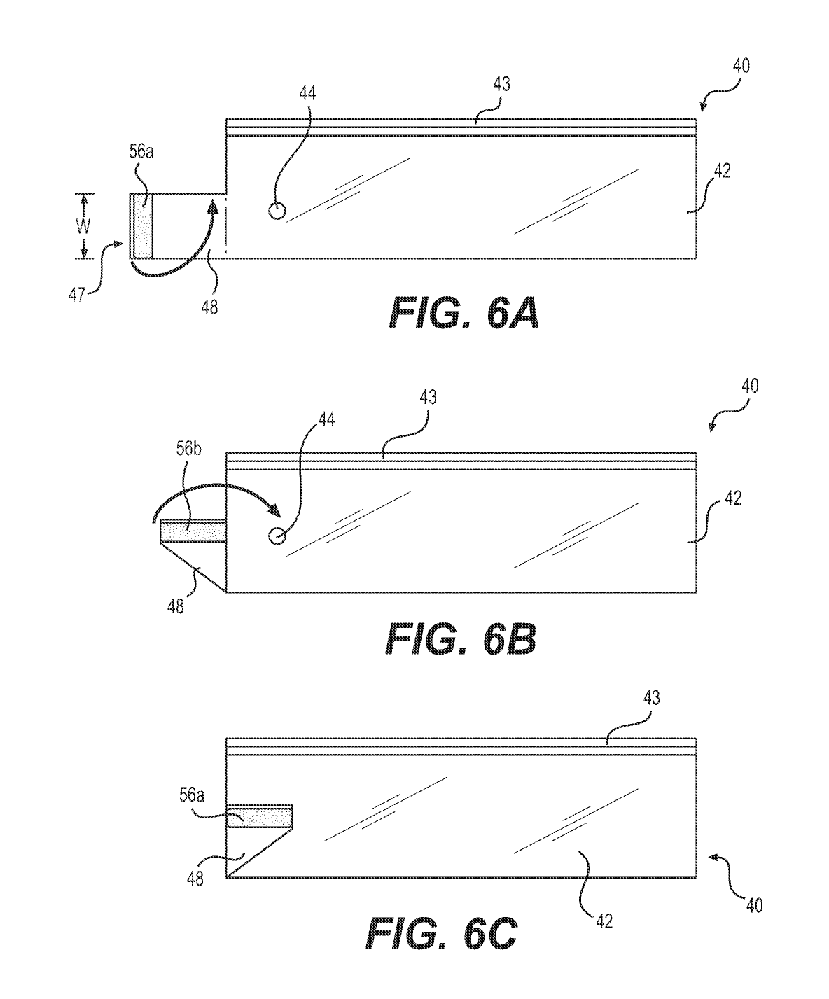

The exit canal wall supports 26a, 26b comprise rigid, flexible members. The wall supports are rigid in that the wall supports tend to maintain their original shape unless/until a force is applied against them to bend them (as described above), and in that the exit canal wall supports 26a, 26b return to their original shape once such a force is removed (unless something (such as the neck of a water bottle) prevents such a return to their original shape). The wall supports are flexible in that the wall supports may be curvedly bent by a user simply applying a squeezing pressure at opposing edges. The combination of rigidity and flexibility cause the wall supports to curvedly bend, rather than angularly bend, when such a pressure is applied. The wall supports may be made of any suitable rigid, flexible material, including any suitable plastic. While FIGS. 4-5 show the exit canal wall supports 26a, 26b comprising generally rectangular structures with diagonal bracing, embodiments of the invention may have exit canal wall supports of any suitable structure, shape, and/or size. Structurally simpler supports are illustrated in the embodiments of FIGS. 6-11.

A bag of embodiments of the invention (excluding the wall supports or the zipper-type closure) may be made of any suitable material, including any suitable plastic film (such as polyethylene) or any suitable foil. If desired, all materials used to construct a bag of embodiments of the invention will comprise food-safe materials. Typically, a bag of embodiments of the invention will be constructed using the same material as a conventional plastic storage bag (again, excluding the wall supports or the closure). A bag of embodiments of the invention may be transparent, semi-transparent, or solid in color. The closure at the main opening of a bag of embodiments of the invention may be constructed as any suitable conventional bag closure, including but not limited to zipper-type or slider-type closures. A bag of embodiments of the invention can be refilled and reused as desired or disposed of after one or more uses. A bag of embodiments of the invention has a means to direct a measured amount of its contents from a main area of storage into a built-in funnel for distribution into another container. Embodiments of the invention reduce or eliminate spillage during the transfer process. Embodiments of the invention allow numerous measured amounts to dispense through its built in funnel without refilling the storage bag. Other means for directing and distributing the storage container's contents could also be utilized other than a funnel built into the bag invention. The opening of the built in funnel can have a means other than a folded crease as shown to close preventing the bag's contents from undesired emptying or spillage. A bag of embodiments of the invention may use various means to separate the opening to the funnel portion from the other portion of the storage bag or container. One means for closing the funnel opening from the other portion 18 of the storage bag is by folding the built in funnel. The funnel canal 16 may be closed by folding creating a crease or it may be closed by other means to prevent spillage until it's desired to dispense the contents of the bag or storage container.

A bag of embodiments of the invention comprises of at least one compartment for storage of various materials which may or may not benefit from an evenly controlled dispensing of the stored contents. A bag of embodiments of the typically invention has at least one opening for loading product with the example shown as the main closure component 13 for the bag 10. The bag size, shape, color and material thickness can vary as determined by users' desired needs.

The exit canal of the attached funnel on a bag of embodiments of the invention can be a shape and a size to fit securely in the standard disposable water or drink bottles available in the market or other types of containers (e.g., baby bottle) where a directed flow of the storage bag's content would be beneficial. The built in funnel portion of a bag of embodiments of the invention can have markings to indicate different measured amounts which can be used to determine the desired amounts of the bag's contents to be dispensed. The built in funnel portion may also be marked by users with a pen or other marking device indicating the amount desired for their special, customized or personal needs. The exit canal of the funnel or spout of the funnel may be made of a different material or have installed a component that assists in holding its shape for dispensing of the storage container's contents.

The spout or exit canal of the built in funnel may have a stiffer plastic or utilize other material built in that keeps the canal closed and relatively flat until pressure is applied by the user to its edges which permits the installation of the exit canal of the funnel into the entry point for a bottle. Upon releasing the applied pressure to the edges of the exit canal of the funnel the exit canal of the funnel forms approximately to the shape of the entrance of the bottle. This provides a more efficient dispensing of the built in funnel's contents. Additionally, this concept could also be applied to the opening to the main cavity of the built-in funnel. Another means to closing off either or both of the funnel's main cavity or the funnel's exit canal or spout could be a zipper type closure or another means entirely.

FIGS. 6A-6C show front view of a storage and dispensing bag 40 of alternative embodiments of the present invention. As in bag 10, bag 40 also comprises a built-in funnel or spout 48 for dispensing contents from the bag 40 into a bottle. Bag 40 comprises a main body 42 forming a cavity for storing contents to be dispensed into a bottle. The main body 42 has a selectively sealable main opening 43 for placing the contents into the cavity. The selectively sealable main opening 43 may comprise a conventional zipper-type closure, or may comprise a slider-type closure. The bag further comprises a funnel or spout 48 connected to the main body 42. The spout 48 is adapted for dispensing the contents from the main body into a bottle. The spout has a proximal opening at a proximal end of the spout. The proximal opening of the spout is connected to a corresponding secondary opening in the main body that is separate from the main opening. While the proximal opening of the spout and the secondary opening of the main body are not labeled, both are located where the spout 48 meets the main body 42. The spout 48 further comprises a distal opening 47 at a distal end of the spout.

The bag 40 further comprises first and second spout wall supports 56a, 56b affixed to or embedded in opposing sides of the spout 48 adjacent the distal opening 47. Because the first and second spout wall supports 56a, 56b are affixed on opposing sides of the spout 48, only one wall support is visible in each of FIGS. 6A-C (different ones are visible in FIGS. 6A-C because different sides of the spout 48 are seen as the spout is folded). The spout wall supports 56a, 56b enable the distal opening 47 to be widened and held in such a widened position while the contents of the bag 40 are dispensed, as described in more detail below.

The spout wall supports 56a, 56b comprise rigid, flexible members. The wall supports are rigid in that wall supports tend to maintain their original shape unless/until a force is applied against them to bend them (as described further below), and in that the spout wall supports 56a, 56b return to their original shape once such a force is removed (unless something (such as the neck of a water bottle) prevents such a return to their original shape). The spout wall supports are flexible in that the wall supports may be curvedly bent by a user simply applying a squeezing pressure at opposing edges. The combination of rigidity and flexibility causes the spout wall supports to curvedly bend, rather than angularly bend, when such a pressure is applied. The spout wall supports may be made of any suitable rigid, flexible material, including any suitable plastic.

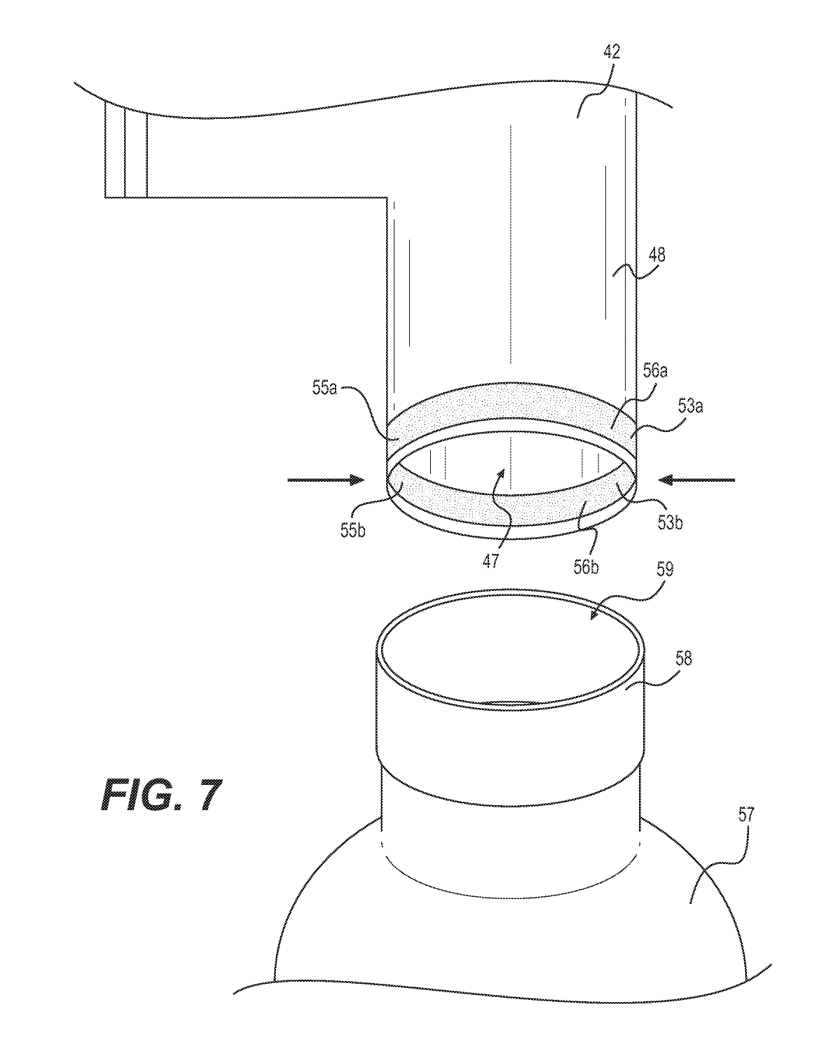

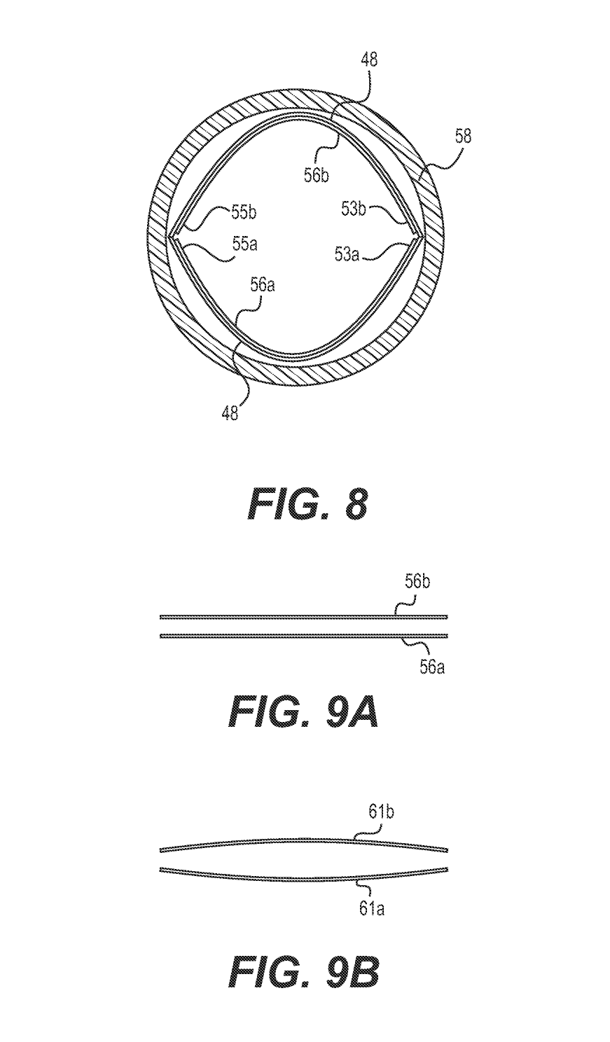

The first spout wall support 56a comprises a first end 53a and a second end 55a. The second spout wall support 56b comprises a first end 53b and a second end 55b. The first ends 53a, 53b of the first and second spout wall supports are adjacent each other in the spout 48 (this is best seen in FIG. 7). The second ends 55a, 55b of the first and second spout wall supports are adjacent each other in the spout 48 (this is best seen in FIG. 7). The first and second spout wall supports 56a, 56b are adapted to each bend outward from the other when longitudinal force is applied at the first ends 53a, 53b and at the second ends 55a, 55b to cause the opposing sides of the spout to separate to facilitate dispensing of the contents (see FIGS. 7-8 and further description below).

The main body 18 of the spout 48 may be folded and then attached to the side of the main body 42 of the storage bag 40, such as by utilizing the securing device 44, causing a crease at the point where the spout 48 attaches to the main body 42, thereby preventing the contents in the main body 42 of the storage bag 40 from escaping into the spout 48. FIG. 6A shows the bag 40 with the spout 48 in a fully unfolded position for dispensing. FIG. 6B shows the bag 40 with the spout 48 folded diagonally upon itself, as a first step in closing off the spout 48 to secure the contents within the bag 40, such as for storage or transportation. FIG. 6C shows the bag 40 with the spout 48 folded again upon the main body 42 of the bag 40, as a final step in closing off the spout 48 to secure the contents within the bag 40. When folded upon the main body 42, the spout 48 may be affixed to the main body 42 using fastener 44.

The securing device 44 may comprise any suitable mechanism for selectively securing the spout 48 to the main body 42 of the bag 40. For example, the securing device 44 may comprise mating hook and loop fastener components affixed to the spout and the bag (not illustrated). As another example, the securing device may comprise a mildly adhesive disk or the like affixed to the spout only, to the bag only (see FIGS. 6A-B), or to the spout and the bag.

As discussed above, FIGS. 6A-C show the steps of folding the spout 48 and securing to the main body 42 of the bag 40 so that the contents are secured within the cavity of the main body 42. When it is desired to dispense the contents into a bottle, this process is reversed. The spout 48 is detached from the securing device 44, eliminating the fold where the spout 48 is attached to the main body 42. The spout 48 is then unfolded again so that the spout 48 is fully unfolded, thereby allowing the contents in the main body 42 of the storage bag 40 to flow freely into the spout 48.

FIG. 7. shows a close up view of the funnel of the bag of FIGS. 6A-6C as it is about to be placed into a mouth of a bottle 57. Such a bottle 57 may be, for example, a standard disposable water bottle. In other embodiments of the invention, the bottle may be a standard baby bottle. FIG. 7 depicts how a longitudinal force or pressure (illustrated by the arrows in FIG. 7) may be applied (e.g., by the fingers of a user's hand as the user grips the side edges of the spout 48, at the location of the spout wall supports) to the first ends 53a, 53b and to the second ends 55a, 55b of the spout wall supports 56a, 56b. (Although not entirely clear in FIG. 7, the first and second wall supports 56a, 56b are typically (but not necessarily) separate and independent elements, albeit closely positioned to each other.) Applying such force causes the spout wall supports 56a, 56b to curvedly bend outward from each other as seen in FIG. 7. This curvedly bending of the spout wall supports 56a, 56b enlarges the opening 47 to facilitate the flow of contents out of the spout, while at the same time creating a shape enabling the distal end of the spout 48 to be inserted into the mouth 59 of the bottle 57.

The distal end of the spout 48 and the spout wall supports 56a, 56b are sized such that, once the distal end of the spout 48 is within the mouth of the bottle, the user may stop applying pressure at the opposing side edges without the spout wall supports 56a, 56b returning to their original shapes and causing the opening 47 to close back up. Instead, the spout wall supports 56a, 56b will attempt to return to their original shapes (i.e., to straighten out), but will contact the neck 58 of the bottle 57 and therefore be prevented from returning to their original shape (while the distal end of the spout is in the mouth of the bottle). By preventing the spout wall supports 56a, 56b from returning to their original shape, the opening 47 of the spout 48 remains widened to continue to facilitate the flow of the contents from the spout 48 into the bottle. The applied pressure that the spout wall supports 56a, 56b create against the neck wall of the bottle provides and secures an adequate opening for contents to exit into the desired container.

Thus, in use, a user applies longitudinal force to the first ends 53a, 53b and to the second ends 55a, 55b of the spout wall supports 56a, 56b, thereby causing the spout wall supports 56a, 56b to curvedly bend outward from each other and arranging the distal end of the spout 48 into a shape that can be inserted into the mouth 59 of the bottle 57. The user then inserts the distal end of the spout 48 into the mouth 59 of the bottle 57 and releases the longitudinal force. Releasing the longitudinal force allows the spout wall supports 56a, 56b to attempt to return to their original shapes. However, the neck 58 of the bottle 57 will prevent the spout wall supports 56a, 56b from fully returning to their original shapes. As such, the distal opening 47 at a distal end of the spout 48 will remain at least partially enlarged to permit the contents to flow into the bottle 57.

FIG. 8 is a cross-sectional view across the neck 58 of the bottle 57 of FIG. 7 after the spout 48 of the bag 40 of FIGS. 6A-C has been placed into the neck 58. FIG. 8 illustrates how the spout wall supports 56a, 56b curvedly bend causing the spout 48 to fit within the neck 58 of the bottle 57. FIG. 8 also illustrates how, when the longitudinal force is removed, the spout wall supports 56a, 56b attempt to return to their original shape but are restricted by the neck 58. The gap between the first ends 53a and 53b and the gap between the second ends 55a and 55b may vary from what is shown in FIG. 8, however these gaps will typically be very small or even nonexistent (i.e., first end 53a may contact first end 53b and second end 55a may contact second end 55b).

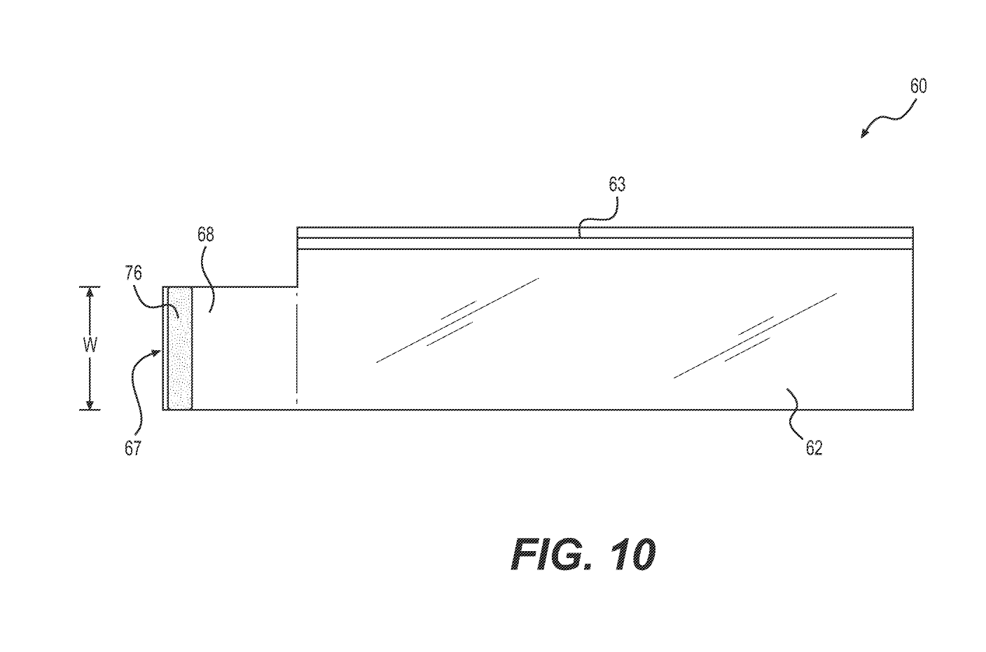

FIGS. 9A-B are top views of spout wall supports in accordance with two different embodiments of the invention. The spout wall supports may comprise first spout wall support 56a and second spout wall support 56b that are each straight and parallel to each other when in the original position (i.e., before the longitudinal force is applied), as illustrated in FIG. 9A. Alternatively, The spout wall supports may comprise first spout wall support 61a and second spout wall support 61b that are each inherently curved outwardly from each other when in the original position (i.e., before the longitudinal force is applied), as illustrated in FIG. 9B. Such inherent outward curvature of the spout wall supports may more readily facilitate the desired outward curved bending of the spout wall supports when the longitudinal force is applied.

The spout wall supports may be planar. Alternatively, the spout wall supports may have one or more ridges or bends formed in each spout wall support along a length of each spout wall support. Such a longitudinal ridge or bend may increase the strength of the spout wall support and may enable thinner material to be used for the spout wall supports while maintaining the desired strength.

The distal end of the spout 48 and the spout wall supports 56a, 56b may be sized to dispense the contents of the bag 40 into a standard disposable water bottle. The neck of a standard disposable water bottle has an internal diameter of about 22 millimeters (mm). Thus, the width of the distal opening 47 of the spout 48 (indicated by W on FIG. 6A) should be no longer than about 35 mm. Any longer than about 35 mm and the distal end of the spout 48 would not fit into the mouth 59 of the water bottle 57, regardless of the amount of longitudinal force applied to the ends of the spout wall supports 56a, 56b. The width of the distal end can be less than the diameter of the neck 58 of the water bottle 57, however in such an embodiment the user would need to maintain the longitudinal force even when the distal end is in the mouth of the water bottle as the neck of the water bottle will not maintain the distal opening 47 of the spout 48 in the desired widened position.

FIG. 10 illustrates a storage and dispensing bag 60 in accordance with alternative embodiments of the invention. The bag 60 of FIG. 10 is nearly identical to the bag 40 of FIGS. 6A-C, but the bag 60 of FIG. 10 has a wider distal spout end (indicated by W on FIG. 10) to be used with a standard baby bottle (which has a wider mouth than does a standard disposable water bottle). The bag 60 of FIG. 10 comprises a main body 62 forming a cavity for storing contents to be dispensed into a bottle. The main body 62 has a selectively sealable main opening 63 for placing the contents into the cavity. As illustrated, the selectively sealable main opening 63 may comprise a conventional zipper-type closure, or may comprise a slider-type closure. The bag further comprises a funnel or spout 68 connected to the main body 62. The spout 68 is adapted for dispensing the contents from the main body into a bottle. The spout 68 further comprises a distal opening 67 at a distal end of the spout. The bag 60 further comprises first and second spout wall supports (only one is visible in FIG. 10 and is labeled 76). As in bag 40, the spout wall supports 76 enable the distal opening 67 to be widened and held in such a widened position while the contents of the bag 60 are dispensed.

The distal opening of the spout 68 and the spout wall supports 76 may be sized to dispense the contents of the bag 60 into a standard baby bottle (not illustrated). The neck of a standard baby bottle has an internal diameter of about 33 millimeters (mm). Thus, the width of the distal end of the spout 68 (indicated by W on FIG. 10) should be no longer than about 50 mm. Any longer than about 50 mm and the distal end of the spout 68 would not fit into the mouth of a standard baby bottle, regardless of the amount of longitudinal force applied to the ends of the spout wall supports 76. The width of the distal end of the spout 68 can be less than the diameter of the neck of the baby bottle, however in such an embodiment the user would need to maintain the longitudinal force even when the distal end is in the mouth of the baby bottle as the neck of the baby bottle will not maintain the distal opening 67 of the spout 68 in the desired widened position.

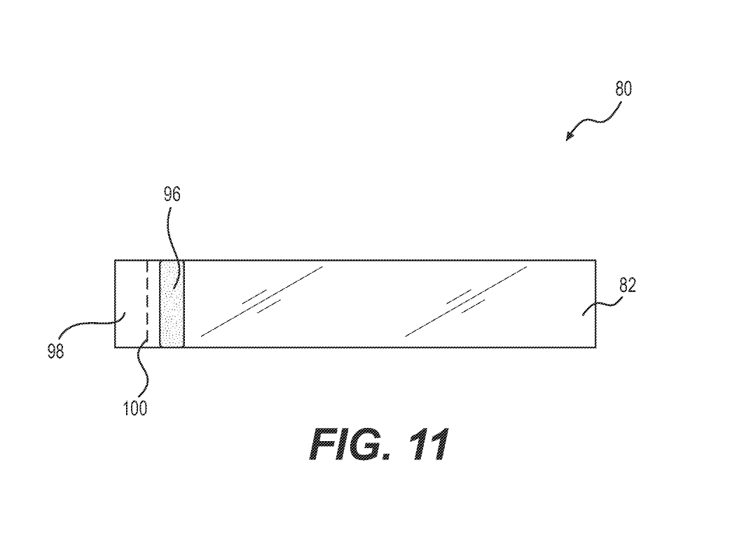

FIG. 11 shows a single-serving storage and dispensing bag 80, in accordance with alternative embodiments of the invention. The bag 80 of FIG. 11 comprises an elongated tubular main body 82 with sealed ends, thereby forming a cavity for storing contents to be dispensed into a bottle. Sealed end 98 is adapted to be torn off the main body 82 by a user such that an opening is formed in the main body 82 when end 98 is torn off. A perforation 100 or similar mechanism (e.g., a notch) may be included to more easily enable a user to tear of one of the sealed ends. The bag 80 further comprises first and second spout wall supports (only one is visible in FIG. 11 and is labeled 96). As in bag 40 and bag 60, the spout wall supports 96 enable the opening formed when the sealed end 98 is torn off to be widened and held in such a widened position while the contents of the bag 80 are dispensed.

The opening formed in the main body 82 may be inserted into a bottle for dispensing the contents of bag 80 into the bottle, in a similar manner as described above in relation to bag 10, bag 40, and bag 60. The bag 80 of FIG. 11 may be sized to dispense its contents into a standard disposable water bottle. Alternatively, the bag 80 of FIG. 11 may be sized to dispense its contents into a standard baby bottle.

The tubular and sealed nature of the main body 82 of the bag 80 allows bag 80 to be readily filled by a machine to produce large numbers of prefilled, sealed bags (filled with, for example, a powdered drink mix or powdered baby formula).

Although the preceding description contains significant detail, it should not be construed as limiting the scope of the invention but rather as providing illustrations of the preferred embodiments of the invention. As an example, the built in funnel portion of the device could take many different forms and shapes as well as the means for closure for both the body of the built-in funnel and the funnel canal. An alternative for the securing device of the built in funnel and its exit canal could be one of many method options including something as simple as a paper clip or other types of clamps made with plastic, metal or other material. The funnel may be folded twice or more before a securing device is administered to further prevent spillage. The funnel may be a separate component that attaches to bags that are currently on the market as needed. The attachment could be by adhesive or by other means.

It is an object to have bags of embodiments of the invention that can effectively dispense its contents without the use of spoons, funnels or other separate elements.

It is another object to have bags of embodiments of the invention that can have the contents viewed quickly through the use of a transparent or semi transparent material.

It is another object to have bags of embodiments of the invention with a built in funnel that can be easily secured and sealed to prevent further dispensing of its contents and to keep stored contents in the preferred state.

It is another object to save time and money by being able to dispense the content of bags of embodiments of the invention quickly without spillage or waste.

It is another object to have bags of embodiments of the invention with markings that indicate the different measurement amounts that may be desired and can be dispensed as desired by users.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

That which is claimed:

1. A storage and dispensing bag comprising:
a main body forming a cavity for storing contents to be dispensed into a bottle, the main body having a selectively sealable main opening for placing the contents into the cavity; and
a spout connected to the main body, the spout adapted for dispensing the contents from the main body into the bottle, the spout comprising:
a proximal opening at a proximal end of the spout, the proximal opening being connected to a corresponding secondary opening in the main body, the secondary opening being separate from the main opening;
a distal opening at a distal end of the spout; and
first and second rigid, flexible members affixed to or embedded in opposing sides of the spout adjacent the distal opening, the first rigid, flexible member comprising a first end and a second end, the second rigid, flexible member comprising a first end and a second end, the first ends of the first and second rigid, flexible members being adjacent each other, the second ends of the first and second rigid, flexible members being adjacent each other, the first and second rigid, flexible members adapted to each bend outward from the other when longitudinal force is applied at the first ends and at the second ends to cause the opposing sides of the spout to separate to facilitate dispensing of the contents.

2. The bag of claim 1, wherein the distal opening and the first and second rigid, flexible members are sized such that, when longitudinal force is applied at the first ends and at the second ends, the distal opening fits within a mouth of a standard disposable water bottle, and such that the longitudinal force may be removed and the mouth of the standard disposable water bottle will prevent the first and second rigid, flexible members from fully returning to original, non-bent positions such that the opposing sides of the spout remain at least partly separated while the distal end remains within the mouth of the standard disposable water bottle.

3. The bag of claim 2, wherein a width of the distal opening when the opposing sides of the spout are not separated is 35 millimeters or less.

4. The bag of claim 1, wherein the distal opening and the first and second rigid, flexible members are sized such that, when longitudinal force is applied at the first ends and at the second ends, the distal opening fits within a mouth of a standard baby bottle, and such that the longitudinal force may be removed and the mouth of the standard baby bottle will prevent the first and second rigid, flexible members from fully returning to original, non-bent positions such that the opposing sides of the spout remain at least partly separated while the distal end remains within the mouth of the standard baby bottle.

5. The bag of claim 4, wherein a width of the distal opening when the opposing sides of the spout are not separated is 50 millimeters or less.

6. The bag of claim 1, wherein the spout is adapted to be folded onto itself at least one time, wherein the folded spout is adapted to be folded onto the main body, and wherein the bag further comprises a securing device for securing the folded spout to the main body.

7. A method of dispensing contents from a bag into a bottle, the method comprising:
(a) placing the contents into a storing and dispensing bag, the bag comprising:
a main body forming a cavity for storing the contents, the main body having a selectively sealable main opening for placing the contents into the cavity; and
a spout connected to the main body, the spout adapted for dispensing the contents from the main body into the bottle, the spout comprising:
a proximal opening at a proximal end of the spout, the proximal opening being connected to a corresponding secondary opening in the main body, the secondary opening being separate from the main opening;
a distal opening at a distal end of the spout;
first and second rigid, flexible members affixed to or embedded in opposing sides of the spout adjacent the distal opening, the first rigid, flexible member comprising a first end and a second end, the second rigid, flexible member comprising a first end and a second end, the first ends of the first and second rigid, flexible members being adjacent each other, the second ends of the first and second rigid, flexible members being adjacent each other, the first and second rigid, flexible members adapted to each bend outward from the other when longitudinal force is applied at the first ends and at the second ends to cause the opposing sides of the spout to separate to facilitate dispensing of the contents.
(b) sealing the selectively sealable main opening;
(c) applying longitudinal force at the first ends and at the second ends to cause the opposing sides of the spout to separate;
(d) inserting the distal end of the spout into a mouth of the bottle;
(e) releasing the longitudinal force;
(f) arranging the bag such that the contents is dispensed from the cavity into the spout and from the spout into the bottle; and
(g) after a desired amount of the contents is dispensed into the bottle, removing the distal end of the spout from the mouth of the bottle.

8. The method of claim 7, wherein the distal opening and the first and second rigid, flexible members are sized such that, when longitudinal force is applied at the first ends and at the second ends, the distal opening fits within a mouth of a standard disposable water bottle, and such that the longitudinal force may be removed and the mouth of the standard disposable water bottle will prevent the first and second rigid, flexible members from fully returning to original, non-bent positions such that the opposing sides of the spout remain at least partly separated while the distal end remains within the mouth of the standard disposable water bottle.

9. The method of claim 8, wherein a width of the distal opening when the opposing sides of the spout are not separated is 35 millimeters or less.

10. The method of claim 7, wherein the distal opening and the first and second rigid, flexible members are sized such that, when longitudinal force is applied at the first ends and at the second ends, the distal opening fits within a mouth of a standard baby bottle, and such that the longitudinal force may be removed and the mouth of the standard baby bottle will prevent the first and second rigid, flexible members from fully returning to original, non-bent positions such that the opposing sides of the spout remain at least partly separated while the distal end remains within the mouth of the standard baby bottle.

11. The method of claim 10, wherein a width of the distal opening when the opposing sides of the spout are not separated is 50 millimeters or less.

12. A single-serving storage and dispensing bag comprising:
an elongated tubular main body having opposing sealed ends forming a cavity for storing contents to be dispensed into a bottle, one opposing sealed end being adapted to be torn off the main body by a user such that an opening is formed in the main body when the one opposing sealed end is torn off;
first and second rigid, flexible members affixed to or embedded in opposing sides of the main body adjacent where the opening will be formed in the main body when the one opposing sealed end is torn off, the first rigid, flexible member comprising a first end and a second end, the second rigid, flexible member comprising a first end and a second end, the first ends of the first and second rigid, flexible members being adjacent each other, the second ends of the first and second rigid, flexible members being adjacent each other, the first and second rigid, flexible members adapted to each bend outward from the other when longitudinal force is applied at the first ends and at the second ends to cause the opposing sides of the main body adjacent the opening formed in the main body to separate to facilitate dispensing of the contents.

13. The bag of claim 12, wherein (a) the opening formed in the main body and (b) the first and second rigid, flexible members are sized such that, when longitudinal force is applied at the first ends and at the second ends, the opening formed in the main body fits within a mouth of a standard disposable water bottle, and such that the longitudinal force may be removed and the mouth of the standard disposable water bottle will prevent the first and second rigid, flexible members from fully returning to original, non-bent positions such that the opposing sides of the main body remain at least partly separated while the opening formed in the main body remains within the mouth of the standard disposable water bottle.

14. The bag of claim 13, wherein a width of the main body when the opposing sides of the main body are not separated is 35 millimeters or less.

15. The bag of claim 12, wherein (a) the opening formed in the main body and (b) the first and second rigid, flexible members are sized such that, when longitudinal force is applied at the first ends and at the second ends, the opening formed in the main body fits within a mouth of a standard baby bottle, and such that the longitudinal force may be removed and the mouth of the standard baby bottle will prevent the first and second rigid, flexible members from fully returning to original, non-bent positions such that the opposing sides of the main body remain at least partly separated while the opening formed in the main body remains within the mouth of the standard baby bottle.

16. The bag of claim 15, wherein a width of the main body when the opposing sides of the main body are not separated is 50 millimeters or less.

17. A method of dispensing contents from a single-serving bag into a bottle, the method comprising:
(a) retrieving a single-serving bag containing contents to be dispensed, the bag comprising:
an elongated tubular main body having opposing sealed ends forming a cavity for storing contents to be dispensed into a bottle, one opposing sealed end being adapted to be torn off the main body by a user such that an opening is formed in the main body when the one opposing sealed end is torn off;
first and second rigid, flexible members affixed to or embedded in opposing sides of the main body adjacent where the opening will be formed in the main body when the one opposing sealed end is torn off, the first rigid, flexible member comprising a first end and a second end, the second rigid, flexible member comprising a first end and a second end, the first ends of the first and second rigid, flexible members being adjacent each other, the second ends of the first and second rigid, flexible members being adjacent each other, the first and second rigid, flexible members adapted to each bend outward from the other when longitudinal force is applied at the first ends and at the second ends to cause the opposing sides of the main body adjacent the opening formed in the main body to separate to facilitate dispensing of the contents.
(b) tearing off one opposing sealed end of the main body to form an opening in the main body;
(c) applying longitudinal force at the first ends and at the second ends to cause the opposing sides of the main body adjacent the opening formed in the main body to separate;
(d) inserting the opening formed in the main body into a mouth of the bottle;
(e) releasing the longitudinal force;
(f) arranging the bag such that the contents is dispensed from the cavity through the opening formed in the main body and into the bottle; and
(g) after a desired amount of the contents is dispensed into the bottle, removing the opening formed in the main body from the mouth of the bottle.

18. The method of claim 17, wherein (a) the opening formed in the main body and (b) the first and second rigid, flexible members are sized such that, when longitudinal force is applied at the first ends and at the second ends, the opening formed in the main body when the one opposing sealed end is torn off fits within a mouth of a standard disposable water bottle, and such that the longitudinal force may be removed and the mouth of the standard disposable water bottle will prevent the first and second rigid, flexible members from fully returning to original, non-bent positions such that the opposing sides of the main body remain at least partly separated while the opening formed in the main body remains within the mouth of the standard disposable water bottle.

19. The method of claim 18, wherein a width of the main body when the opposing sides of the main body are not separated is 35 millimeters or less.

20. The method of claim 17, wherein (a) the opening formed in the main body and (b) the first and second rigid, flexible members are sized such that, when longitudinal force is applied at the first ends and at the second ends, the opening formed in the main body fits within a mouth of a standard baby bottle, and such that the longitudinal force may be removed and the mouth of the standard baby bottle will prevent the first and second rigid, flexible members from fully returning to original, non-bent positions such that the opposing sides of the main body remain at least partly separated while the opening formed in the main body remains within the mouth of the standard baby bottle.

21. The method of claim 20, wherein a width of the main body when the opposing sides of the main body are not separated is 50 millimeters or less.
